(19) United States
(12) Patent Application Publication
(10) Pub. No.: US 2026/0338638 A1
(43) Pub. Date: Oct. 29, 2026

(54) TESTING DEVICES FOR EVALUATING A FIBER OPTICAL SYSTEM

(71) Applicant: CORNING RESEARCH & DEVELOPMENT CORPORATION, Corning, NY (US)

(72) Inventors: Shane Blackburn Harmon, Statesville, NC (US); Radawan Ripumaree, Hickory, NC (US)

(21) Appl. No.: 19/649,675

(22) Filed: Apr. 16, 2026

Related U.S. Application Data
(60) Provisional application No. 63/795,809, filed on Apr. 28, 2025.

(51) Int. Cl. G01M 11/00; G01M 11/02; G02B 6/38

(52) U.S. Cl. CPC G01M 11/37; G01M 11/0207; G02B 6/3827

(57) ABSTRACT

A loopback device for evaluating a fiber optical system includes a housing defining an enclosure, a ferrule positioned at a first end of the housing, and an indicator cap positioned at a second end of the housing. The loopback device also includes a fiber loop disposed within the enclosure of the housing and the indicator cap. The housing and ferrule are operable to be inserted into a port of a terminal device. The fiber loop includes at least one optical fiber having an input end and an output end at an end face of the ferrule. The input end is operable to receive an input optical signal from the port and provide an output optical signal to the port at the output end. The input optical signal is operable to cause the indicator cap to illuminate by transmission of at least a portion of the input optical signal through the indicator cap when the input optical signal propagates within the at least one optical fiber.

### BACKGROUND

This application claims the benefit of priority of U.S. Provisional Application Ser. No. 63/795,809 filed on Apr. 28, 2025, the content of which is relied upon and incorporated herein by reference in its entirety.

### BACKGROUND

Fiber optical systems are used in optical telecommunications to send optical signals from one location to another. Fiber optical systems typically employ an optical fiber cable that defines an optical link that optically connects one piece of optical equipment at one location (i.e., on one side of the optical link) to another piece of optical equipment at another location (i.e., on the other side of the optical link). For example, the optical link may be between a server in a data center/central office and a computer at a control center. In many cases, the optical fiber cable supports multiple optical fibers over which the optical signals are transmitted and received in both directions using transmitters and receivers (e.g., transceivers) at both ends of the optical link.

Fiber-based loopback devices are often used to test the performance of fiber optical systems by providing an optical communication path over at least a portion of the optical link between a transmitter and a receiver at the same piece of optical equipment, i.e., on the same side of the optical link. This allows for the performance of the fiber optical system to be evaluated and managed from one end of the system.

However, present loopback devices do not allow a field technician to test and evaluate operation of an optical communication link within the fiber optical system remotely from the field. Rather, present loopback devices require an operator at both ends of the optical link (e.g., both at a terminal device and a data center or central office). This increases both the cost and the amount of time needed for an optical communication link to be tested and evaluated. As the densification of optical networks increase and wiring schemes become increasingly complex there is a need for such remote testing.

Accordingly, alternative devices and methods for testing an optical communication link may be desired.

### BRIEF SUMMARY

In one embodiment, a loopback device for evaluating a fiber optical system includes a housing defining an enclosure, a ferrule positioned at a first end of the housing, and an indicator cap positioned at a second end of the housing. The loopback device also includes a fiber loop disposed within the enclosure of the housing and the indicator cap, where the housing and ferrule are operable to be inserted into a port of a terminal device. The fiber loop includes at least one optical fiber having an input end and an output end at an end face of the ferrule. The input end of the at least one optical fiber is operable to receive an input optical signal from the port at the input end and provide an output optical signal to the port at the output end. The input optical signal is operable to cause the indicator cap to illuminate by transmission of at least a portion of the input optical signal through the indicator cap when the input optical signal propagates within the at least one optical fiber.

In another embodiment, a fiber optical system includes a terminal device having an input port and at least one output port, a multifiber connector coupled to the input port, the multifiber connector operable to provide one or more input signals to the terminal device and receive one or more output signals from the terminal device. The fiber optical system also includes a loopback device coupled to the at least one output port. The loopback device includes a housing defining an enclosure, a multifiber ferrule positioned at a first end of the housing, and an indicator cap positioned at a second end of the housing. The loopback device includes a fiber loop disposed within the enclosure of the housing and the indicator cap, where the fiber loop includes a plurality of optical fibers. Each optical fiber has an input end operable to mate with an output optical fiber of the at least one output port and an output end operable to mate with an input optical fiber of the at least one output port at an end face of the ferrule. The input end of each optical fiber of the plurality of optical fibers is operable to receive an input optical signal from the at least one port at the input end and provide an output optical signal to the at least one port at the output end, and the input optical signal is operable to cause the indicator cap to illuminate by transmission of at least a portion of the input optical signal through the indicator cap when the input optical signal propagates within one or more optical fibers of the plurality of optical fibers.

In another embodiment, a testing device for evaluating a fiber optical system includes a housing defining an enclosure, a ferrule positioned at a first end of the housing, and an indicator cap positioned at a second end of the housing. The testing device also includes an optical fiber disposed within the enclosure of the housing and the indicator cap, where the housing and ferrule are operable to be inserted into a port of a terminal device. The optical fiber has an input end at an end face of the ferrule and an output end that terminates in the indicator cap. The input end of the optical fiber is operable to receive an input optical signal from the port at the input end, and the input optical signal exits the output end of the optical fiber and is operable to cause the indicator cap to illuminate by transmission of at least a portion of the input optical signal through the indicator cap.

In another embodiment, a testing system for evaluating a fiber optical system a testing device and a detection device. The testing device includes a housing defining an enclosure, a ferrule positioned at a first end of the housing and an indicator cap positioned at a second end of the housing. The testing device also includes at least one optical fiber disposed within the enclosure of the housing and the indicator cap. The housing and ferrule are operable to be inserted into a port of a terminal device. The optical fiber has an input end an end face of the ferrule and an output end that terminates in the indicator cap. The input end of the optical fiber is operable to receive an input optical signal from the port at the input end, and the input optical signal is operable to cause the indicator cap to illuminate by transmission of at least a portion of the input optical signal through the indicator cap. The detection device operable to detect an optical power emitted at the indicator cap.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example multiport terminal and a loopback device according to one or more embodiments described and illustrated herein.

FIG. 2 illustrates the example multiport terminal and loopback device of FIG. 1 according to one or more embodiments described and illustrated herein.

FIG. 3A illustrates a ferrule, a fiber manager and a fiber loop of an example loopback device according to one or more embodiments described and illustrated herein.

FIG. 3B illustrates a housing and fiber loop of an example loopback device according to one or more embodiments described and illustrated herein.

FIG. 4A illustrates a front perspective view of an example loopback device according to one or more embodiments described and illustrated herein.

FIG. 4B illustrates a rear perspective view of the example loopback device of FIG. 4A according to one or more embodiments described and illustrated herein.

FIG. 4C illustrates a side view of the example loopback device of FIGS. 4A and 4B according to one or more embodiments described and illustrated herein.

FIG. 5 illustrates an end face of an example multifiber ferrule of a loopback device according to one or more embodiments described and illustrated herein.

FIG. 6 illustrates an example fiber loop and multifiber ferrule mated to a port ferrule of an output port of a terminal device according to one or more embodiments described and illustrated herein.

### DETAILED DESCRIPTION

Embodiments of the present disclosure provide testing devices, such as a loopback devices, that are operable to provide a field technician with a quick and effective way to test and evaluate an optical communication link terminating at an output port of a terminal device, such as a multiport terminal device. The testing devices of the present disclosure produce a visual indication for the field technician to see or measure with a power device the operation of an optical communication link. This allows real time testing and troubleshooting for complex optical networks.

More particularly, an input optical signal having one or more wavelengths in the visible spectrum is launched into an optical fiber within the testing device such that an indicator cap of the testing device glows or otherwise illuminates. A glowing indicator cap indicates that an optical fiber of an output port receives an optical signal and is functioning properly. In some embodiments, the testing device is a loopback device whereby one or more optical fibers provide a loop at a ferrule of the loopback device, thereby optically linking input and output fibers of the tested port. Visible light is emitted from the fiber loop which causes the indicator cap to illuminate when the visible light is transmitted through the material of the indicator cap. A field technician may use a detection device to measure the optical power and determine an amount of loss in some embodiments. The testing devices of the present disclosure allow terminal devices to be quickly tested in the field without needing communication back to a central office.

Various embodiments of testing devices and methods of evaluating an optical communication system are described in detail below.

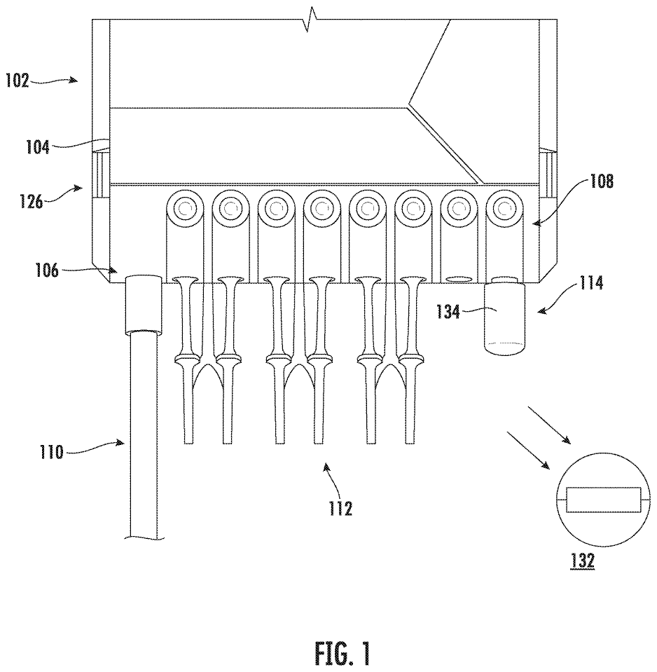

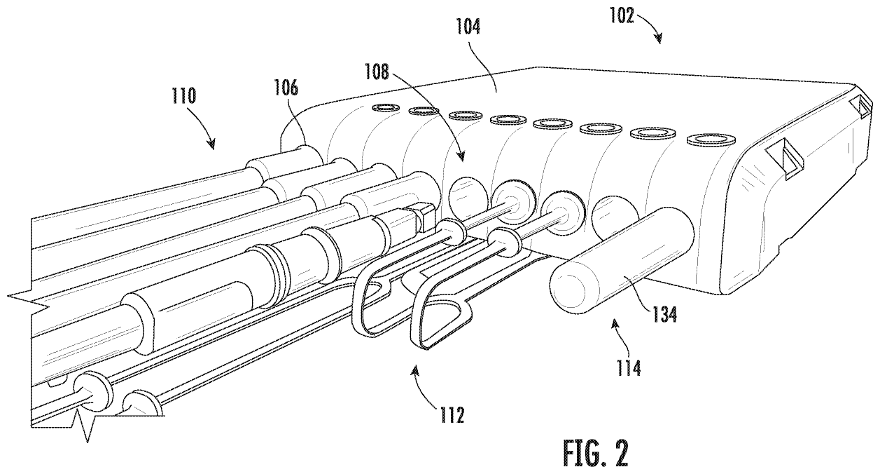

Referring now to FIG. 1 and FIG. 2, an example multiport terminal 102 is illustrated. The multiport terminal 102 is a device of a fiber optic network that allows multiple fiber optic connectors to be optically coupled to an input optical connector. Such multiport terminals 102 are often used to connect drop cables that are routed to individual subscribers to a single input optical input cable 110. In the illustrated embodiment, the multiport terminal 102 has a housing 104 that provides an input port 106 and a plurality of output ports 108. The multiport terminal 102 of FIG. 1 is illustrated as an Evolv™ terminal manufactured and sold by Corning Optical Communications of Charlotte, NC. However, it should be understood that the terminal devices of the present disclosure are not limited to Evolv® terminals and that other terminal device configurations are contemplated.

The input port 106 is located at the leftmost position and the plurality of output ports 108 are at the first through eighth output port positions, thereby providing eight output ports. One or more of the output ports 108 may be passthrough ports intended to route a plurality of optical fibers to a downstream terminal device. Some or all of the output ports may be connected to connectorized drop cables that are routed to individual subscribers, such as homes and businesses.

A connector of the input cable 110 is inserted into the input port 106. The input cable 110 is optically coupled to a remote office. For example, input cable 110 may be a branch cable that is spliced from, or otherwise connected to, a main trunk cable. The input cable 110 may include a plurality of optical fibers. One or more splitter devices or other multiplexing devices may be maintained within the enclosure of the housing 104. The splitter or multiplexing devices may split and/or combine optical signals between the plurality of output ports 108 and the input port 106.

The connector of the input cable 110 and the connector of any output cables may be configured as Pushlok® optical connectors sold by Corning Optical Communications. It should be understood that other connector styles may be used depending on the configuration of the multiport terminal 102.

FIG. 1 and FIG. 2 shows the first six output ports closed by the use of dust plugs 112. Dust plugs 112 may be provided in unused ports to environmentally protect the multiport terminal 102 from moisture, dust and debris as multiport terminals 102 are often aerially installed or buried in pits.

Although the multiport terminal 102 is illustrated as having eight output ports, embodiments are not limited thereto. For example, embodiments of the present disclosure may be utilized in conjunction with terminal devices having any number of input ports and any number of output ports, including a single output port.

FIG. 1 illustrates the eighth output port as having a loopback device 114 inserted therein. The loopback device 114 is operable to allow a technician to quickly and effectively evaluate the status of an individual output port 108 of the multiport terminal 102. As described in more detail below, the loopback device 114 has a body that is shaped as a connector that is operable to be inserted into a port of the multiport terminal 102, which in this case is a Pushlok connector operable to be inserted into an output port 108 of an Evolv multiport terminal. The loopback device 114 includes a plurality of optical fibers arranged in a loop within a indicator cap 134. As described in more detail below, the loopback device 114 includes a multifiber ferrule having an array of fiber positions whereby the input ends of the plurality of optical fibers within the loopback device are positioned at input fiber positions of the multifiber ferrule, and the output ends of the plurality of optical fibers are position at output fiber positions of the multifiber ferrule. Therefore, an optical signal provided by the input cable 110 is received at the input end of an optical fiber of the loopback device, which reroutes the optical signal back into the input cable 110 through the output end of the optical fiber of the loopback device.

To test whether or not optical signals are reaching a fiber position within an individual output port 108, the field technician inserts the body of the loopback device 114 so that it is securely mated with the individual output port 108. Then an input optical signal is provided by a central office to the input cable 110 and the individual fiber position of the ferrule within the individual output port 108. The input optical signal, which is has one or more wavelengths in the visible spectrum, enters the input end of an individual optical fiber of the loopback device 114, propagates within the optical fiber, and is looped back such that it exits the second end of the optical fiber and through the a fiber position of the ferrule within the individual output port 108. Thus, the input optical signal is provided to back to the multiport terminal 102 as a looped-back output optical signal. This output optical signal may then be returned to the central office through the input cable 110 and other intervening optical fibers between the input cable 110 and the central office.

As another example, the field technician may insert a testing device into the input port 106 that is operable to inject optical signals into individual optical fibers of the input port 106. Thus, the testing device may include one or more light sources (e.g., one or more lasers) that are operable to individually provide a test input optical signal into each optical fiber at the input port 106. The testing device and the loopback device 114 may be used in conjunction to evaluate whether or not there are any failures of optical fibers or other optical components (e.g., optical splitters) in the multiport terminal 102.

Some of the input optical signal is emitted from the optical fiber of the loopback device 114. Because the input optical signal has one or more wavelengths in the visible spectrum, the emitted input optical signal passes through the indicator cap 134 of the loopback device 114, thereby causing the indicator cap 134 to illuminate (i.e., transmit optical radiation through the indicator cap 134 at one or more wavelengths in the visible spectrum). The indicator cap 134 is fabricated from a translucent material. As a non-limiting example, the indicator cap 134 may be fabricated from a red translucent material.

An illuminated indicator cap 134 provides a quick and effective way for a field technician to ascertain that an individual fiber position of the output port 108 is receiving an optical signal from the central office or from an input test device. Each individual optical fiber at the output port 108 can be sequentially evaluated. For example, the input optical signal can be provided at the first fiber position, then the second, then the third, and so on.

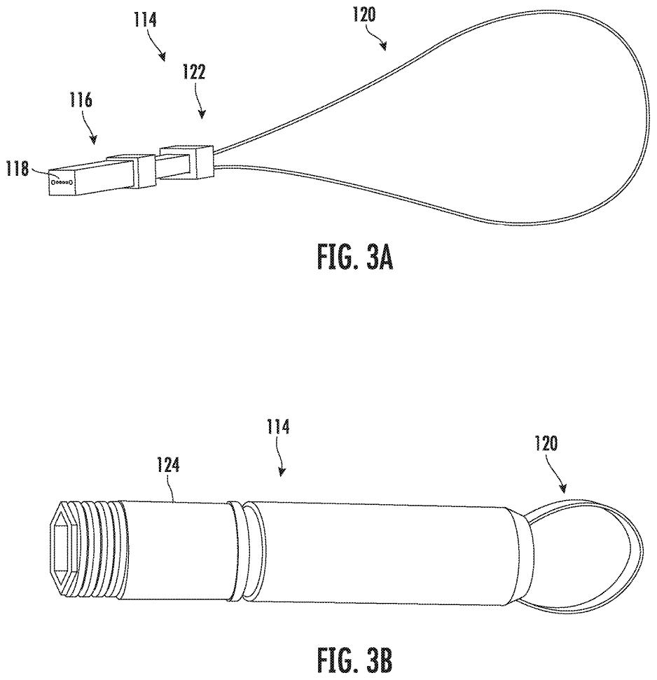

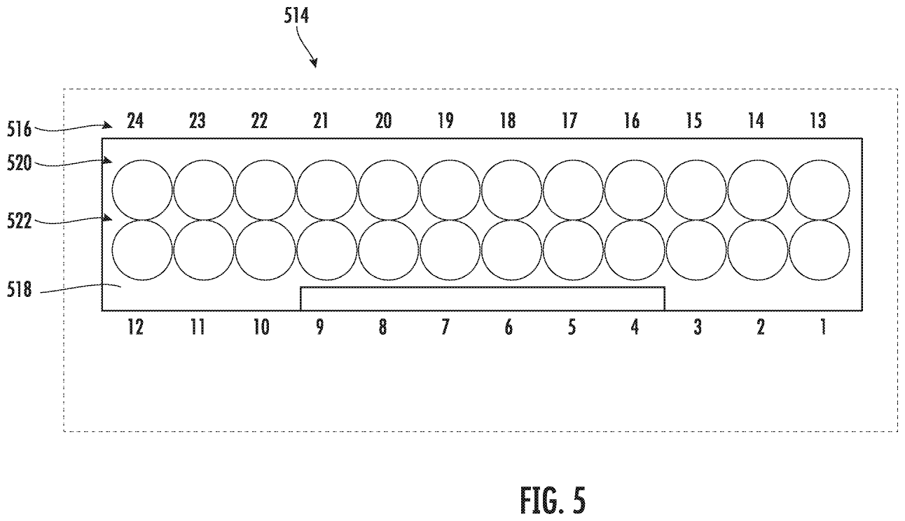

Referring now to FIG. 3A, internal components of an example loopback device 114 are illustrated. The example loopback device 114 includes a ferrule 116 configured as a multifiber ferrule. As a non-limiting example, the ferrule 116 may be a mechanical transfer (MT) ferrule. The ferrule 116 has an end face 118 having fiber positions where the ends of optical fibers of a fiber loop 120 are terminated and exposed. The end face 118 of the ferrule 116 is operable to optically mate with a corresponding port ferrule within an output port 108 of the multiport terminal 102. An example end face 518 of a twenty-four fiber ferrule 516 is illustrated in FIG. 5 and described in detail below.

The fiber loop 120 comprises a plurality of optical fibers (e.g., twenty-four optical fibers) that are arranged in a loopback configuration. In other words, both ends of each optical fiber of the fiber loop 120 are terminated at the end face 118 of the ferrule 116. Thus, an input optical signal inputted into an individual fiber of the fiber loop 120 at the end face 118 of the ferrule 116 is returned to the end face 118 of the ferrule 116. The example loopback device also includes a ferrule seat 122, which is operable to hold the ferrule 116 in a forward position when the loopback device 114 is installed into terminal device.

FIG. 3B illustrates the components shown in FIG. 3A installed within a loopback housing 124. The loopback housing 124 may be sized and configured for any suitable port of a device or terminal as desired. The explanatory housing 124 show in FIG. 3B is configured for a connection port of an Evolv® terminal, thereby allowing the removal of the Pushlok® connector from the output port of an Evolv terminal and inserting the loopback device 414. However, it should be understood that the loopback housing 124 may take on other connector configurations, such as, without limitation, OptiTap® and OptiTip® connectors sold by Corning Optical Communications.

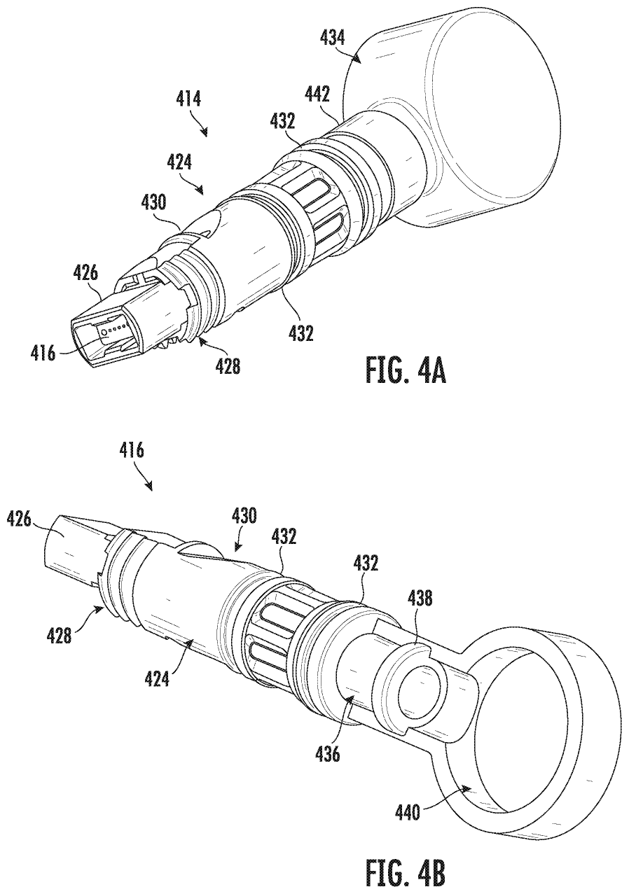

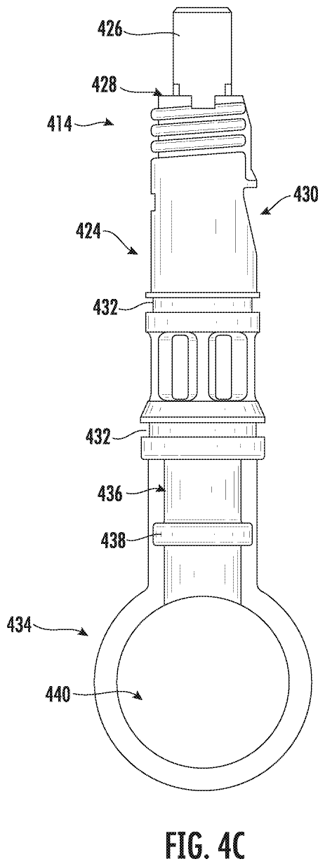

FIGS. 4A-4C illustrate different views of an example loopback device 414. The loopback device 414 is configured to mate with port of a suitable terminal or device and observing optical communication. The lookback device 414 illustrated in FIGS. 4A-4C is configured for being compatible with an Evolv® terminal having a multifiber Pushlok® connector port and operable to be inserted into an output port of the Evolv® multifiber terminal. The loopback device 414 has a nosepiece 426 that extends from a housing 424. The nosepiece 426 surrounds and protects a multifiber ferrule 416. The end face of the ferrule 416 is set back within the nosepiece 426. The ferrule 416 is configured to mate with a corresponding ferrule within an output port of the terminal device. In this loopback device 414, no spring or resilient member is used for biasing the ferrule 416. However, other embodiments may bias the ferrule 416 if desired.

The nosepiece 426 is attached to the housing by having a portion partially received within a passageway defined by the housing 424 such that the housing 424 secures the nosepiece 426. The illustrated nosepiece 426 is explanatory and other devices may have other suitable nosepiece constructions as desired for the connection port or use. This nosepiece 426 has features that correspond with features of the Evolv® terminal with the multifiber Pushlok® connector port.

Other variations of nosepieces are possible as well. For instance, nosepiece 426 may has features that correspond with features, described in U.S. Patent Publ. No. 2025/0035857, the contents of which are incorporated by reference herein.

Returning to FIGS. 4A-4C, the housing 424 has a threaded portion 428 for receiving a dust cap or other protection device. The housing 424 also includes a notch 430 that receives a locking portion (not shown) of an output port that locks the loopback device 414 into the output port. To remove the loopback device 414 from the output port, a corresponding button 126 (see FIG. 1) of a corresponding output port 108 is pressed, which removes the locking portion from the notch 430 and allows the loopback device 414 to be pulled and removed from the output port 108. The housing 424 further includes one or more sealing member grooves 432 to receive sealing members, such as O-rings, that provide environmental sealing when the loopback device 414 is inserted into an output port 108.

The housing 424 is configured for the connection port of a multifiber Evolv® terminal and comprises notch 430 defining a single recessed ramp that receives a locking portion (not shown) of the translating securing member of the output port of the terminal at the recessed portion, thereby securing the loopback device 414 into the output port for use. The single recessed ramp is a negatively defined feature on the housing 424 (defined inward toward the centerline) for creating a compact footprint. This housing 424 also includes a female keyway (not numbered) disposed about 180 degrees opposite the notch 430. The female keyway interrupts the threaded portion 428 and also allows a small form-factor for the loopback device 414.

The example loopback device 414 also includes an indicator cap 434 at a second end defining a cap engagement portion 436 of the housing 424 opposite from the nosepiece 426. The illustrated indicator cap 434 includes a first half and a second half. Each half of the indicator cap 434 has an interior notch 444 that is operable to receive a flange 438 of the housing 424 (FIG. 4C). The first half and the second half of the indicator cap 434 are positioned on the housing 424 such that the flange 438 is disposed within the respective notches 444. The first half and the second half of the indicator cap 438 are secured to the housing by a band 442 (FIG. 4A), such as, without limitation, a heat shrink tube. Other methods of connecting the indicator cap 434 to the cap engagement portion 436 may be utilized, such as by an adhesive.

When assembled, the indicator cap 434 defines a fiber enclosure 440 for the fiber loop 120 (FIG. 3A and FIG. 3B). Therefore, the loop end of the fiber loop 120 is disposed within the fiber enclosure 440. Although the fiber enclosure 440 is illustrated as circular in shape, other shapes are possible, such as rectangular and elliptical.

When visible light enters one of the optical fibers of the fiber loop 120, a portion of the visible light escapes the optical fiber and passes through the translucent material of the indicator cap 434, causing the indicator cap 434 to glow or otherwise illuminate. The bend radius of the loop 120 may be less than a minimum rated bend radius of the optical fibers of the fiber loop 120 to cause light to escape from the optical fibers at the fiber loop 120.

Embodiments may also be utilized in single fiber ports of a terminal device. In such embodiments, the testing device is not a loopback device. Rather, the testing device, which may be configured as described above with respect to the loopback housing and indicator cap, does not have a fiber loop. Single fiber testing devices include a single fiber or fiber stub disposed in a ferrule at one end and terminating within the indicator cap at the other end. When visible light is emitted into the single fiber, it causes the indicator cap to illuminate. Thus, the testing device may be configured to evaluate a single fiber port of a terminal device.

Referring once again to FIG. 1, a testing system may include both the loopback device 114 (or testing device in single fiber applications) and a detection device 132. The detection device 132 includes one or more sensors operable to detect an optical power that is emitted through the indicator cap 134. As a non-limiting example, the detection device 132 may be configured as an optical power meter. The detection device 132 may therefore be used by a field technician to determine optical loss either between the central office and the output port 108 under evaluation when the central office send the input optical signal, or between the input port 106 and the output port 108 under evaluation when the field technician inputs the input optical signal into the multiport terminal 102. A lower optical power reading as compared to a calibrated reading or threshold reading may indicate that there is optical loss present, for example.

FIG. 5 illustrates an example end face 518 of a multifiber ferrule 516 for use in a loopback device 514. This multifiber ferrule 516 comprises fiber bores arranged in a plurality of rows, but the concepts may be used with multifiber ferrules having a single row of fiber bores.

The example multifiber ferrule 516 has twenty-four fiber positions for receiving twenty-four optical fibers of a fiber loop. The fiber positions are arranged in twelve top row ferrule positions 520 and twelve bottom row ferrule positions 522, thereby providing two rows and twelve columns of two fiber positions. It should be understood that the configuration of the multifiber ferrule 516 of FIG. 5 is provided for illustrative purposes only, and that other fiber position configurations are possible.

The end of each optical fiber of the fiber loop is operable to mate with an output optical fiber within an output port of a terminal device. As a non-limiting example, fiber positions one-through twelve on the bottom row ferrule positions 522 may be for input ends of the optical fibers of the fiber loop. Thus, the input ends of the optical fibers at the bottom row ferrule positions 522 receive the input optical signal.

The opposite output ends of the optical fibers are disposed within fiber positions thirteen through twenty-four, and are operable to mate with an input optical fiber within the port of the terminal device. Accordingly, the optical fibers of the fiber loop loopback from the bottom row ferrule positions 522 to the top row ferrule positions 520. For example, a first optical fiber of the fiber loop loops between fiber position one and fiber position thirteen, a second optical fiber of the fiber loop loops between fiber position two and fiber position fourteen, and so on.

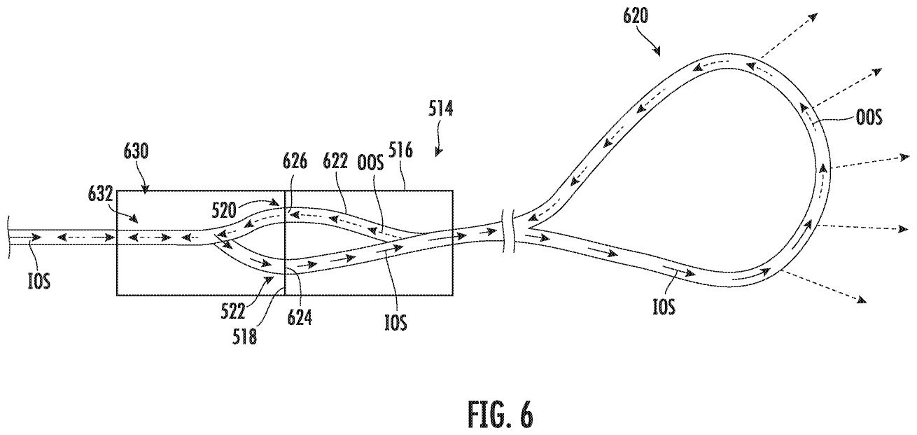

FIG. 6 illustrates a ferrule 516 of a loopback device 514 mated with a port ferrule 630 of an output port. A plurality of port optical fibers 632 are routed into the port ferrule 630 to top row ferrule positions that align with the top row ferrule positions 520 and bottom ferrule positions that align with the bottom row ferrule positions 522 of the ferrule 516 of the loopback device 514. An input optical signal IOS propagates within at least one of the port optical fibers 632 and in the illustrated embodiment is routed to a bottom row ferrule position, where it is received by an input end 624 of an optical fiber of the fiber loop 620. The input optical signal IOS, which is illustrated as solid arrows, travels within the optical fiber of the fiber loop 620. Some of the input optical signal IOS leaks out of the optical fiber as an emitted optical signal EOS, which causes the indicator cap to illuminate as described above. The remainder of the optical signal propagating within the optical fiber of the fiber loop 620 is referred to as an output optical signal OOS, which returns to an output end of the optical fiber at a top row ferrule positions 520 of the end face 518 of the ferrule 516. The output optical signal is received by a port optical fiber where it may exit the terminal device through the input port.

In this manner, an input optical signal having one or more wavelengths in the visible spectrum received from an output optical fiber in the port enters the fiber loop at a bottom row ferrule position and is routed back to a top row ferrule position as an output optical signal. Visible light escapes the optical fiber and causes the indicator cap 134 to illuminate, as described above. In some embodiments, the output optical signal that is returned by the loopback device 114 is received by the central office and evaluated, such as for optical loss within the optical network.

It should now be understood that embodiments of the present disclosure provide a testing device, such as a loopback device, that is operable to provide a field technician a quick and effective way to test and evaluate an output port of a terminal device, such as a multiport terminal device. An input optical signal having one or more wavelengths in the visible spectrum is launched into an optical fiber within the testing device such that an indicator cap of the testing device glows or otherwise illuminates. An illuminating indicator cap indicates that an optical fiber of an output port receives an optical signal and is functioning properly. In some embodiments, the testing device is a loopback device whereby one or more optical fibers provide a loop at a ferrule of the loopback device, thereby optically linking input and output fibers of the port. Visible light is emitted from the fiber loop which causes the indicator cap to illuminate. A field technician may use a detection device to measure the optical power and determine an amount of loss in some embodiments. The testing devices of the present disclosure allow terminal devices to be quickly tested in the field without needing communication back to a central office.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A loopback device for evaluating a fiber optical system, the loopback device comprising:
a housing defining an enclosure;
a ferrule positioned at a first end of the housing;
an indicator cap positioned at a second end of the housing; and
a fiber loop disposed within the enclosure of the housing and the indicator cap, wherein:
the housing and the ferrule are operable to be inserted into a port of a terminal device,
the fiber loop comprises at least one optical fiber having an input end and an output end at an end face of the ferrule,
the at least one optical fiber is operable to receive an input optical signal from the port at the input end and provide an output optical signal to the port at the output end, and
the input optical signal is operable to cause the indicator cap to illuminate by transmission of at least a portion of the input optical signal through the indicator cap when the input optical signal propagates within the at least one optical fiber.

2. The loopback device of claim 1, wherein the at least one optical fiber comprises a plurality of optical fibers and the ferrule is a multifiber ferrule.

3. The loopback device of claim 2, wherein the multifiber ferrule comprises a plurality of fiber bores arranged in a plurality of rows.

4. The loopback device of claim 2, wherein each optical fiber of the plurality of optical fibers is operable to receive the input optical signal at the input end and provide the output optical signal at the output end.

5. The loopback device of claim 2, wherein the indicator cap is fabricated from a translucent material.

6. The loopback device of claim 1, wherein the input optical signal has one or more wavelengths in the visible spectrum.

7. The loopback device of claim 1, further comprising a fiber manager.

8. The loopback device of claim 1, wherein the indicator cap comprises a first half and a second half that are coupled to a cap engagement portion at the second end of the housing.

9. A fiber optical system comprising:
a terminal device comprising an input port and at least one output port;
a multifiber connector coupled to the input port, the multifiber connector operable to provide one or more input signals to the terminal device and receive one or more output signals from the terminal device;
a loopback device coupled to the at least one output port, the loopback device comprising:
a housing defining an enclosure;
a multifiber ferrule positioned at a first end of the housing;
an indicator cap positioned at a second end of the housing; and
a fiber loop disposed within the enclosure of the housing and the indicator cap, wherein:
the fiber loop comprises a plurality of optical fibers, each optical fiber having an input end operable to mate with an output optical fiber of the at least one output port and an output end operable to mate with an input optical fiber of the at least one output port at an end face of the multifiber ferrule,
each optical fiber of the plurality of optical fibers is operable to receive an input optical signal from the at least one output port at the input end and provide an output optical signal to the at least one output port at the output end, and
the input optical signal is operable to cause the indicator cap to illuminate by transmission of at least a portion of the input optical signal through the indicator cap when the input optical signal propagates within one or more optical fibers of the plurality of optical fibers.

10. The fiber optical system of claim 9, wherein each optical fiber of the plurality of optical fibers is operable to receive the input optical signal at the input end and provide the output optical signal at the output end.

11. The loopback device of claim 10, wherein the multifiber ferrule comprises a plurality of fiber bores arranged in a plurality of rows.

12. The loopback device of claim 9, wherein the indicator cap is fabricated from a translucent material.

13. The fiber optical system of claim 9, wherein the input optical signal has one or more wavelengths in the visible spectrum.

14. The fiber optical system of claim 9, further comprising a fiber manager.

15. The fiber optical system of claim 9, wherein the indicator cap comprises a first half and a second half that are coupled to a cap engagement portion at the second end of the housing.

16. The fiber optical system of claim 9, wherein:
the at least one output port comprises a port multifiber connector and a plurality of output optical fibers terminating at the port multifiber connector; and
the output optical fiber is an individual output optical fiber of the plurality of output optical fibers.

17. The fiber optical system of claim 16, wherein:
the plurality of output optical fibers is terminated at an array of ferrule positions configured in at least two rows and a plurality of columns; and
the input end and the output end of each optical fiber are coupled to two ferrule positions in a same column of the array of ferrule positions.

18. A testing device for evaluating a fiber optical system, the testing device comprising:
a housing defining an enclosure;
a ferrule positioned at a first end of the housing;
an indicator cap positioned at a second end of the housing; and
an optical fiber disposed within the enclosure of the housing and the indicator cap, wherein:
the housing and the ferrule are operable to be inserted into a port of a terminal device,
the optical fiber has an input end an end face of the ferrule and an output end that terminates in the indicator cap,
the input end of the optical fiber is operable to receive an input optical signal from the port at the input end, and
the input optical signal exits the output end of the optical fiber and is operable to cause the indicator cap to illuminate by transmission of at least a portion of the input optical signal through the indicator cap.

19. The testing device of claim 18, wherein the indicator cap is fabricated from a translucent material.

20. The testing device of claim 18, wherein the input optical signal has one or more wavelengths in the visible spectrum.

21. The testing device of claim 18, wherein the indicator cap comprises a first half and a second half that are coupled to a cap engagement portion at the second end of the housing.

22. A testing system for evaluating a fiber optical system, the testing system comprising:
a testing device comprising:
a housing defining an enclosure;
a ferrule positioned at a first end of the housing;
an indicator cap positioned at a second end of the housing; and
at least one optical fiber disposed within the enclosure of the housing and the indicator cap, wherein:
the housing and the ferrule are operable to be inserted into an output port of a terminal device,
the at least one optical fiber has an input end at an end face of the ferrule and an output end,
the at least one optical fiber is operable to receive an input optical signal from the output port at the input end, and
the input optical signal is operable to cause the indicator cap to illuminate by transmission of at least a portion of the input optical signal through the indicator cap; and
a detection device operable to detect an optical power emitted at the indicator cap.

23. The testing system of claim 22, wherein:
the ferrule is a multifiber ferrule;
the at least one optical fiber is a plurality of optical fibers arranged in a fiber loop;
the input end of each optical fiber is operable to mate with an output optical fiber of the output port, and the output end of each optical fiber is operable to mate with an input optical fiber of the output port at the end face of the ferrule,
each optical fiber of the plurality of optical fibers is operable to receive the input optical signal from the output port of the terminal device at the input end and provide an output optical signal to the output port at the output end, and
the input optical signal is operable to cause the indicator cap to illuminate by transmission of at least a portion of the input optical signal through the indicator cap when the input optical signal propagates within one or more optical fibers of the plurality of optical fibers.

24. The testing system of claim 22, wherein;
the output end terminates in the indicator cap; and
the at least one optical fiber is operable to receive the input optical signal at the input end and provide an output optical signal at the output end.

25. The testing system of claim 22, wherein the indicator cap is fabricated from a translucent material.

26. The testing system of claim 22, wherein the input optical signal has one or more wavelengths in the visible spectrum.

27. The testing system of claim 22, further comprising a fiber manager.

28. The testing system of claim 22, wherein the indicator cap comprises a first half and a second half that are coupled to a cap engagement portion at the second end of the housing.

29. The testing system of claim 22, wherein:
the at least one fiber comprises a plurality of optical fibers;
the ferrule is a multifiber ferrule having an array of ferrule positions configured in at least two rows and a plurality of columns; and
the input end and the output end of each optical fiber of the plurality of optical fibers are located at two ferrule positions in a same column of the array of ferrule positions.
